(19) United States
(12) Patent Application Publication
(10) Pub. No.: US 2009/0016774 A1
(43) Pub. Date: Jan. 15, 2009

(54) IMAGE FORMING APPARATUS, SCANNING OPTICAL APPARATUS, AND CONTROL METHODS THEREOF

(75) Inventor: Katsuhide Koga, Moriya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/169,417

(22) Filed: Jul. 8, 2008

(30) Foreign Application Priority Data
Jul. 9, 2007 (JP) 2007-180154

(51) Int. Cl. G03G 15/04

(52) U.S. Cl. 399/221

(57) ABSTRACT

The present invention provides an image forming apparatus that adjusts the amount of light of a light-emitting unit with high accuracy and suppresses an increase in control time that is required to adjust the amount of light, a scanning optical apparatus, and control methods thereof. To accomplish this, the image forming apparatus of the present invention derives a threshold current and a bias current of the light-emitting unit. Further, the image forming apparatus of the present invention supplies the bias current to the light-emitting unit when causing the light-emitting unit to emit light in an amount of light corresponding to the minimum density level, and supplies a current that is larger than the threshold current to the light-emitting unit when causing the light-emitting unit to emit light in an amount of light corresponding to a density level that is larger than that minimum density level.

### BACKGROUND OF THE INVENTION

1. Field of the Invention

The present invention relates to an image forming apparatus that includes a scanning optical apparatus for forming an electrostatic latent image on a photosensitive member, a scanning optical apparatus, and control methods thereof.

2. Description of the Related Art

Electrophotographic image forming apparatuses typically include a scanning optical apparatus for forming an electrostatic latent image on a photosensitive member. The scanning optical apparatus includes a semiconductor laser for irradiating light, and adjusts the density of images to be formed by adjusting the intensity (amount) of light that is irradiated. Ordinarily, when a current input to a semiconductor laser reaches a given level, the amount of light starts to show a stable increase. Hereinafter, this given current is referred to as “threshold current”. According to conventional technology, the amount of light is increased proportionally to the increase of density level in the range between a current smaller than the threshold current and a drive current corresponding to the maximum amount of light. However, it has poor tone reproduction capability in low density portions.

Japanese Patent Laid-Open No. H09-069662 proposes a method in which a current for low density portions is controlled to be within the range between a current larger than the threshold value and zero current, and a current for portions other than the low density portions is controlled according to image signals to be in the range between the current larger than the threshold value and the maximum drive current.

However, according to the method described in Japanese Patent Laid-Open No. H09-069662, the drive current for low density portions is set to a current amount that does not cause image fogging in which toner adheres to a region where there is no image information. For this reason, it is necessary to check the occurrence of image fogging by exposing a photosensitive member with the set drive current and measuring the potential of the photosensitive member. As a result, if fogging is found, it is necessary to set the drive current again. Further, another method has been conceived in which the drive current for low density portions is set to a current close to the threshold current. However, this method also requires several times of setting and checking of a D/A for the drive current for low density portions. As described above, the conventional technology requires several times of setting of the drive current to reproduce a density tone with high accuracy, which involves a long control time.

### SUMMARY OF THE INVENTION

The present invention enables realization of an image forming apparatus that adjusts the amount of light of a light-emitting unit with high accuracy and suppresses an increase in control time that is required to adjust the amount of light, a scanning optical apparatus and control methods thereof.

One aspect of the present invention provides an image forming apparatus wherein an amount of light for forming an electrostatic latent image is adjusted according to a density level of an image to be formed, the image forming apparatus comprising: a light-emitting unit adapted to emit light in an amount of light corresponding to an input current; a light-receiving unit adapted to output a current corresponding to an amount of received light; a sampling unit adapted to sample a first amount of light corresponding to a first current that is larger than a threshold current, and a second amount of light corresponding to a second current that is larger than the first current using the light-emitting unit and the light-receiving unit to derive the threshold current, which is a current at which the amount of light emitted by the light-emitting unit starts to increase linearly; a derivation unit adapted to derive the threshold current from the relationship among the first and second currents, and the sampled first and second amount of light; a bias current determination unit adapted to determine a bias current of the light-emitting unit by subtracting a value of a predetermined difference current from a value of the derived threshold current; and a current supply unit adapted to supply the bias current to the light-emitting unit when causing the light-emitting unit to emit light in an amount of light corresponding to a minimum density level, and supply a current that is larger than the threshold current to the light-emitting unit when causing the light-emitting unit to emit light in an amount of light corresponding to a density level that is larger than the minimum density level.

Another aspect of the present invention provides a scanning optical apparatus that is included in an image forming apparatus wherein an amount of light for forming an electrostatic latent image is adjusted according to a density level of an image to be formed, the scanning optical apparatus comprising: a light-emitting unit adapted to emit light in an amount of light corresponding to an input current; a light-receiving unit adapted to output a current corresponding to an amount of received light; a sampling unit adapted to sample a first amount of light corresponding to a first current that is larger than a threshold current, and a second amount of light corresponding to a second current that is larger than the first current using the light-emitting unit and the light-receiving unit to derive the threshold current, which is a current at which the amount of light emitted by the light-emitting unit starts to increase linearly; a derivation unit adapted to derive the threshold current from the relationship among the first and second currents, and the sampled first and second amount of light; a bias current determination unit adapted to determine a bias current of the light-emitting unit by subtracting a value of a predetermined difference current from a value of the derived threshold current; and a current supply unit adapted to supply the bias current to the light-emitting unit when causing the light-emitting unit to emit light in an amount of light corresponding to a minimum density level, and supply a current that is larger than the threshold current to the light-emitting unit when causing the light-emitting unit to emit light in an amount of light corresponding to a density level that is larger than the minimum density level.

Still another aspect of the present invention provides a method for controlling an image forming apparatus that includes a light-emitting unit adapted to emit light in an amount of light corresponding to an input current and a light-receiving unit adapted to output a current corresponding to an amount of received light, and adjusts an amount of light for forming an electrostatic latent image according to a density level of an image to be formed, the method comprising the steps of: sampling a first amount of light corresponding to a first current that is larger than a threshold current, and a second amount of light corresponding to a second current that is larger than the first current using the light-emitting unit and the light-receiving unit to derive the threshold current, which is a current at which the amount of light emitted by the light-emitting unit starts to increase linearly; deriving the threshold current from the relationship among the first and second currents, and the sampled first and second amount of light; determining a bias current of the light-emitting unit by subtracting a value of a predetermined difference current from a value of the derived threshold current; and supplying the bias current to the light-emitting unit when causing the light-emitting unit to emit light in an amount of light corresponding to a minimum density level, and supply a current that is larger than the threshold current to the light-emitting unit when causing the light-emitting unit to emit light in an amount of light corresponding to a density level that is larger than the minimum density level.

Yet another aspect of the present invention provides a method for controlling a scanning optical apparatus that is included in an image forming apparatus that includes a light-emitting unit adapted to emit light in an amount of light corresponding to an input current and a light-receiving unit adapted to output a current corresponding to an amount of received light, and adjusts an amount of light for forming an electrostatic latent image according to a density level of an image to be formed, the method comprising the steps of: sampling a first amount of light corresponding to a first current that is larger than a threshold current, and a second amount of light corresponding to a second current that is larger than the first current using the light-emitting unit and the light-receiving unit to derive the threshold current, which is a current at which the amount of light emitted by the light-emitting unit starts to increase linearly; deriving the threshold current from the relationship among the first and second currents, and the sampled first and second amount of light; determining a bias current of the light-emitting unit by subtracting a value of a predetermined difference current from a value of the derived threshold current; and supplying the bias current to the light-emitting unit when causing the light-emitting unit to emit light in an amount of light corresponding to a minimum density level, and supply a current that is larger than the threshold current to the light-emitting unit when causing the light-emitting unit to emit light in an amount of light corresponding to a density level that is larger than the minimum density level.

Further features of the present invention will be apparent from the following description of exemplary embodiments with reference to the attached drawings.

### BRIEF DESCRIPTION OF THE DRAWINGS

FIG. 1 is a cross-sectional view illustrating the overall configuration of a printer 100 according to an embodiment of the present invention.

FIG. 2 is a diagram illustrating the configuration of a laser exposure unit 101 according to an embodiment of the present invention.

FIG. 3 is a block diagram illustrating the configuration of a laser drive control unit 54 according to an embodiment of the present invention.

FIG. 4A is a functional block diagram of an APC control unit 311 according to an embodiment of the present invention.

FIG. 4B is a diagram illustrating the circuit configuration of the APC control unit 311 according to an embodiment of the present invention.

FIG. 5 is a graph illustrating the relationship between the current that is input to a semiconductor laser 43 and the amount of light that is emitted.

FIG. 6A is a diagram illustrating current changes during an APC control according to an embodiment of the present invention.

FIG. 6B is a flowchart illustrating the procedure of the APC control according to an embodiment of the present invention.

FIG. 7A is a block diagram illustrating the configuration of a laser drive control unit 54 when an image signal having three bits is input.

FIG. 7B is a diagram used to illustrate currents that are set when an image signal having three bits is input.

### DESCRIPTION OF THE EMBODIMENTS

A preferred embodiment of the present invention will now be described in detail with reference to the drawings. It should be noted that the relative arrangement of the components, the numerical expressions and numerical values set forth in these embodiments do not limit the scope of the present invention unless it is specifically stated otherwise.

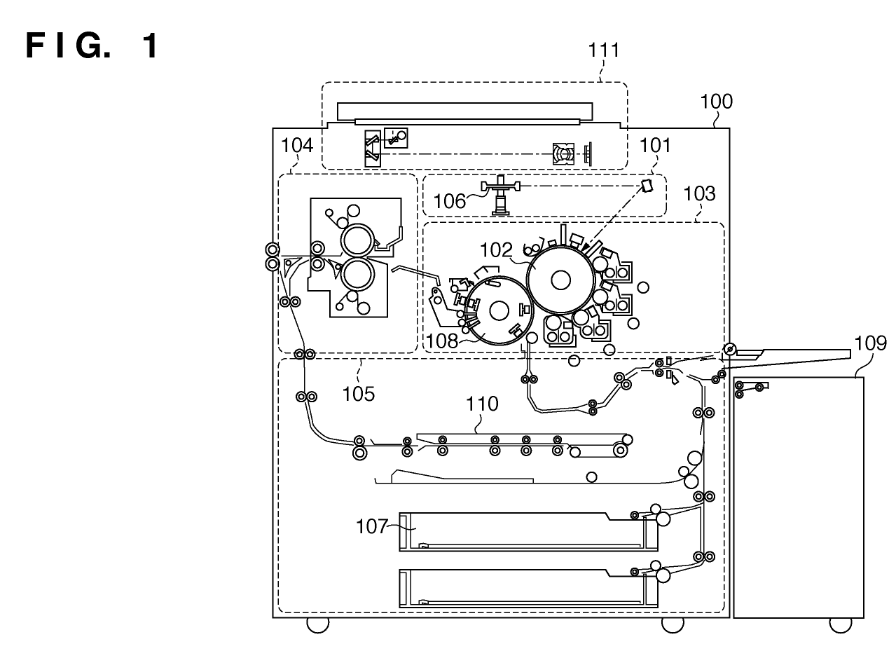

Hereinafter, an embodiment of the present invention will be described with reference to FIGS. 1 to 6B. FIG. 1 is a cross-sectional view illustrating the overall configuration of a printer 100 according to an embodiment of the present invention. Here, an electrophotographic printer 100 will be described as an example of an image forming apparatus.

The printer 100 includes a scanner unit 111, a laser exposure unit 101, an image forming unit 103, a fixing unit 104, a paper feed/transport unit 105, and a printer control unit (not shown) that controls these units.

The scanner unit 111 irradiates light onto an original document placed on an original plate for optical scanning, and converts the scanned image into an electric signal to generate image data. The laser exposure unit 101 causes laser light that has been modulated based on the generated image data to be incident on a rotating polygonal mirror 106 that rotates at a constant angular velocity, and to be irradiated to a photosensitive drum 102 as reflected scanning light.

The image forming unit 103 includes the photosensitive drum 102 and a transfer drum 108. When image formation is started, the image forming unit 103 drives the photosensitive drum 102 to rotate, and causes the surface of the photosensitive drum 102 to be charged by a charger. Then, an electrostatic latent image formed on the photosensitive drum 102 by the laser exposure unit 101 is developed with toner, and the obtained toner image is transferred onto paper. The image forming unit 103 removes a small amount of residual toner that has not been transferred and is left on the photosensitive drum 102 using a cleaner. An electrophotographic process is performed in this manner.

In the image forming process, paper fed from a paper feed cassette 107 is wound around a predetermined position of the transfer drum 108. While the transfer drum 108 is rotated four times, the electrophotographic process is executed sequentially by magenta (M), cyan (C), yellow (Y) and black (K) developing units (developing stations) having respective toners. Thereby, a full color (four color) toner image is transferred onto the paper. After the toner image has been transferred, the paper is separated from the transfer drum 108 and is transported to the fixing unit 104.

The fixing unit 104 is configured of a combination of rollers and belts, and includes a heat source, such as a halogen heater. The fixing unit 104 fixes the toner on the paper by fusing the toner with the application of heat and pressure.

The paper feed/transport unit 105 includes at least one paper container, such as a paper feed cassette 107 or a paper deck 109, and feeds paper, sheet by sheet, from the paper container, which holds a plurality of sheets of paper, in accordance with the instructions of the printer control unit. The paper is wound around the transfer drum 108 of the image forming unit 103 as described above, and is transported to the fixing unit 104 after the transfer drum 108 has been rotated four times. When forming images on both sides of paper, the paper feed/transport unit 105 transports paper that has passed through the fixing unit 104 again to the image forming unit 103 through a transport path 110.

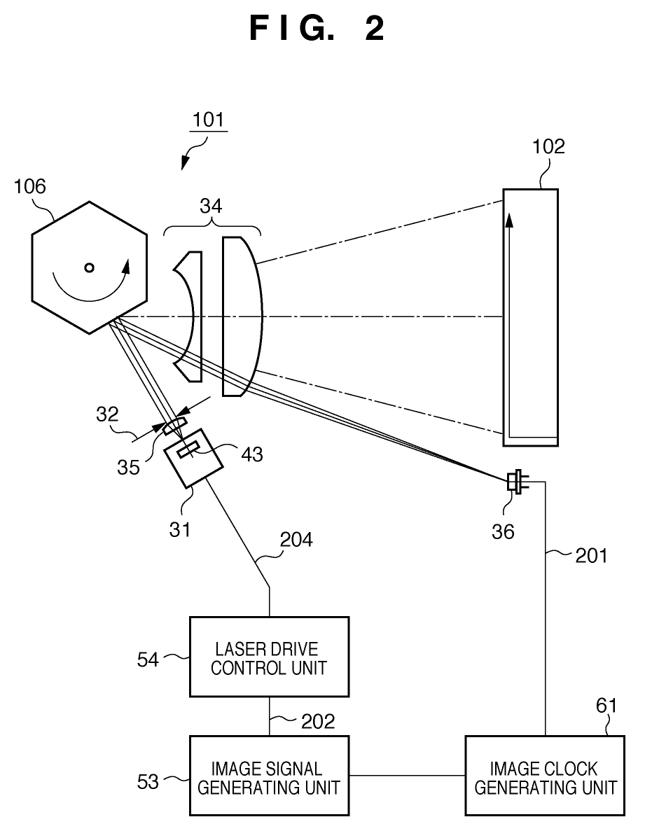

The basic operation of the laser exposure unit 101 that functions as a scanning optical apparatus will be described with reference to FIG. 2. FIG. 2 is a diagram illustrating the configuration of the laser exposure unit 101 according to the present embodiment.

The laser exposure unit 101 includes a laser drive apparatus 31, an aperture 32, a collimating lens 35, a BD sensor 36, an fθ lens 34, and a rotating polygonal mirror 106. The laser exposure unit 101 is connected to a laser drive control unit 54, an image signal generating unit 53 and an image clock generating unit 61, in order to control the laser exposure unit 101.

The laser drive apparatus 31 functions as a light-emitting unit, and irradiates light to the rotating polygonal mirror 106 using a semiconductor laser 43 that is included in the laser drive apparatus 31. The semiconductor laser 43 emits light in an amount of light corresponding to an input current. The BD sensor 36 receives the light that has been reflected by the rotating polygonal mirror 106, and outputs a detection signal 201 to the image clock generating unit 61.

The detection signal 201 of the BD sensor 36 is used as a synchronizing signal for synchronizing the rotation of the rotating polygonal mirror 106 and data writing. The image clock generating unit 61 outputs an image clock synchronized with the synchronizing signal sent from the BD sensor 36 to the image signal generating unit 53. Upon receiving an input of the image clock, the image signal generating unit 53 generates an image signal 202 and outputs the signal to the laser drive control unit 54. The laser drive control unit 54 drives the semiconductor laser 43 based on the image signal 202 to let it emit laser light. A PD sensor that functions as a light-receiving unit and detects a part of the laser light is provided in the semiconductor laser 43.

The laser exposure unit 101 according to the present embodiment performs APC control (amount of light adjustment) of the semiconductor laser 43 using a detection signal of the PD sensor. The laser light emitted from the semiconductor laser 43 is converted into substantially collimated light by the collimating lens 35 and the aperture 32, and is incident on the rotating polygonal mirror 106 with a predetermined beam diameter. The rotating polygonal mirror 106 rotates at a constant angular velocity in the direction of the arrow. With this rotation, the incident light beam is reflected as a deflected beam whose direction is continuously changed. The deflected beam is focused by the fθ lens 34. At the same time, the fθ lens 34 corrects distortion aberration so as to secure temporal linearity of the scanning. Thereby, the light beam is converged/scanned on the photosensitive drum 102 in the direction of the arrow at a constant velocity.

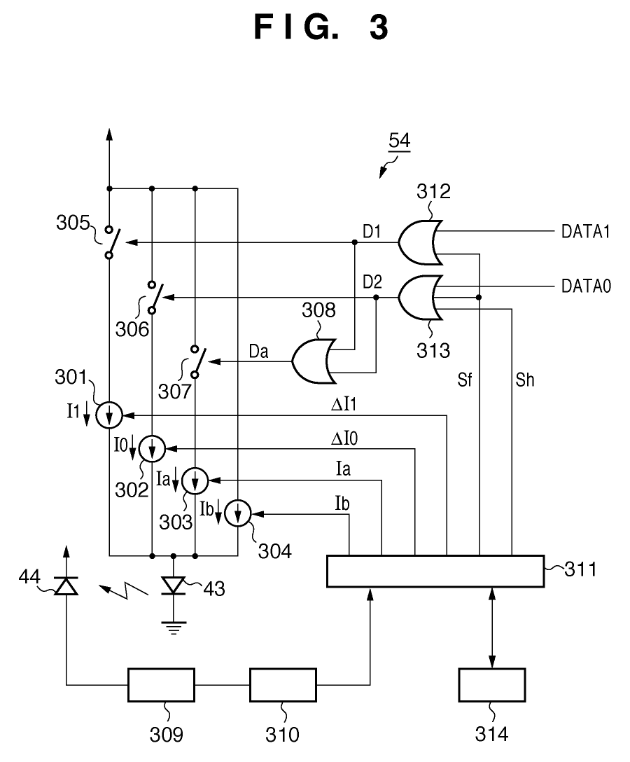

The operation of the laser drive control unit 54 will be described next with reference to FIG. 3. FIG. 3 is a block diagram illustrating the configuration of the drive control unit 54 according to the present embodiment. In order to simplify the description, the configuration of a case where the image signal has two bits (DATA1 and DATA0) will be described. It should be noted, however, that the printer 100 according to the present invention is not limited to the use of image signals having two bits.

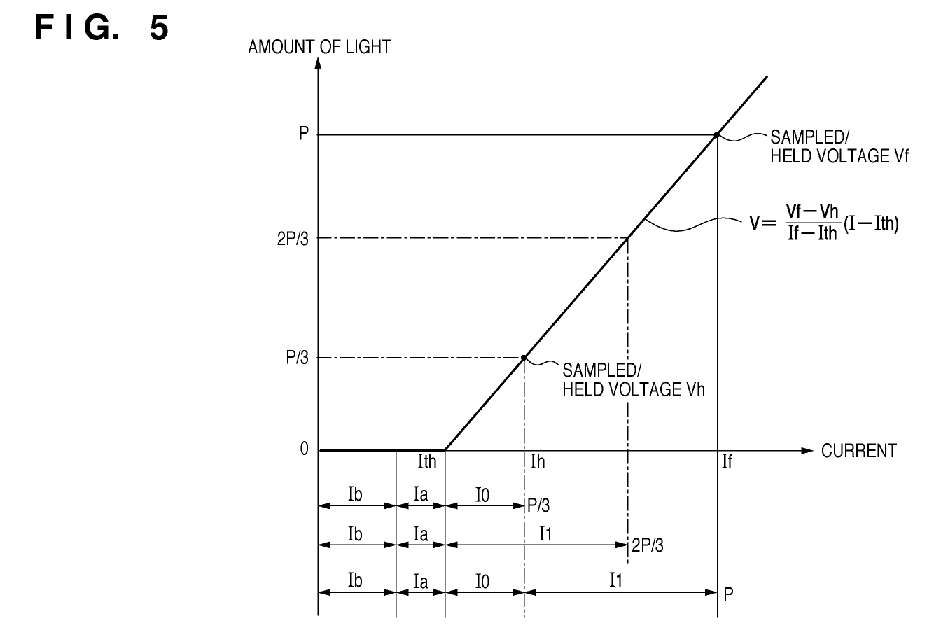

The semiconductor laser 43 is connected to current sources 301, 302, 303 and 304. The current sources 301 and 302 are drive current sources that are driven in response to image signals to cause the semiconductor laser 43 to emit light in an amount other than the minimum amount of light. The current source 303 is a difference current source that outputs a difference current. The current source 304 is a bias current source that outputs a bias current of the semiconductor laser 43. As used herein, “threshold current” refers to the current at which the amount of light emitted from the semiconductor laser 43 starts to increase linearly. Likewise, “difference current” refers to the difference between the threshold current and the bias current. The threshold current and the difference current will be described later in detail with reference to FIG. 5.

The drive current source 301 is also connected to a switch 305. The switch 305 is connected to a logic element 312 that performs an OR operation of DATA1 (the high-order bit of the image signal) and a full lighting signal Sf. Accordingly, the switch 305 switches the drive current source 301 on and off in accordance with an output D1 from the logic element 312. The drive current source 302 is connected to a switch 306 that switches the drive current source 302 on and off in accordance with an output D2 from a logic element 313 that performs an OR operation of DATA0 (the low-order bit of the image signal), the full lighting signal Sf and a partial lighting signal Sh. The difference current source 303 is connected to a switch 307 that switches the difference current source 303 on and off in accordance with an output Da from a logic element 308 that performs an OR operation of the outputs D1 and D2. Accordingly, the difference current source 303 is driven whenever at least one of the drive current sources 301 and 302 is driven.

Reference numeral 314 shown in FIG. 3 denotes a printer control unit. Reference numeral 311 denotes an APC control unit. Reference numeral 309 denotes a current/voltage converting unit. Reference numeral 310 denotes an amplifier. The printer control unit 314 controls the APC control unit 311 by outputting control signals. The APC control unit 311 controls the switches 305, 306 and 307 according to the control signals from the printer control unit 314, and supplies currents corresponding to the image signal to the semiconductor laser 43. The semiconductor laser 43 emits light in an amount of light corresponding to the input currents.

The amount of light of the light emitted from the semiconductor laser 43 is monitored by the PD sensor 44, where a current corresponding to that amount of light is generated. The current corresponding to the amount of light that is output from the PD sensor 44 is converted into a voltage by the current/voltage converting unit 309. The converted voltage is amplified by the amplifier 310, and is input to the APC control unit 311. The APC control unit 311 adjusts the current values of the current sources (301 to 304) according to the input voltage. The APC control unit 311 also adjusts those current values according to signals that are input in a non-image region covered by a single scan. Further, the APC control unit 311 adjusts the amount of light emitted from the semiconductor laser 43 according to DATA1 and DATA0 of the image signal input in a non-image region covered by a single scan by changing the switches 305, 306 and 307.

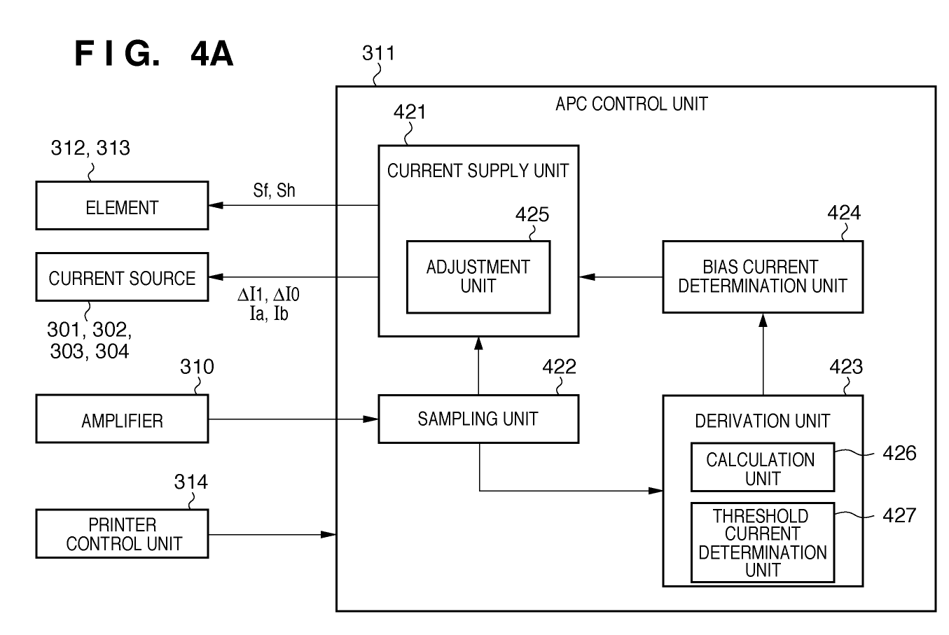

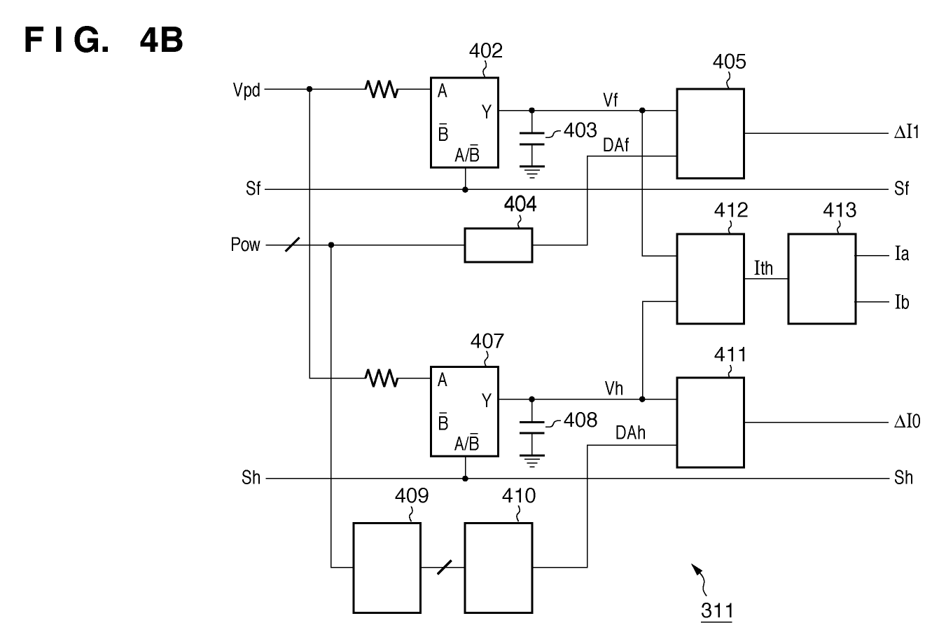

The operation of the APC control unit 311 will be described next with reference to FIGS. 4A to 5. FIG. 4A is a functional block diagram of the APC control unit 311 according to the present embodiment. FIG. 4B is a diagram illustrating the circuit configuration of the APC control unit 311 according to the present embodiment. FIG. 5 is a graph illustrating the relationship between the current that is input to the semiconductor laser 43 of the present embodiment and the amount of light that is emitted.

The APC control unit 311 adjusts the amount of light of the light that is emitted from the semiconductor laser 43 to provide a density level corresponding to the input image signal. Specifically, the APC control unit 311 controls the current sources 301 to 304 shown in FIG. 3 to control the current that is input to the semiconductor laser 43. Here, the characteristics of the semiconductor laser 43 will be described with reference to FIG. 5. FIG. 5 shows the current that is input to the semiconductor laser 43 on the horizontal axis and the amount of light that is emitted from the semiconductor laser 43 on the vertical axis. Ib represents a bias current that is output from the bias current source 304. Ia represents a difference current that is output from the difference current source 303. I0 represents a drive current that is output from the drive current source 302. I1 represents a drive current that is output from the drive current source 301. Ith represents a threshold current.

As shown in FIG. 5, the relationship between the current that is input to the semiconductor laser 43 and the amount of light that is emitted is nonlinear. Specifically, the output of the semiconductor laser 43 is unstable until the threshold current Ith is reached, and it starts to increase linearly after the threshold current Ith. The APC control unit 311 controls the amount of light such that the amount of light increases proportionally to an increase in density level to be reproduced by deriving the threshold current Ith. Upon derivation of the threshold current Ith, the APC control unit 311 determines a bias current Ib from a difference current Ia. This difference current Ia is a predetermined current for making the bias current sufficiently small to lie in an unstable region that is lower than the threshold current Ith. For example, if the image signal represents 0, that is, the minimum density level, the APC control unit 311 inputs only the bias current Ib to the semiconductor laser 43. However, if the bias current Ib has a value close to the threshold current Ith, the amount of light that is emitted will be unstable, causing image fogging or the like. Accordingly, in order to make the bias current Ib sufficiently small, the difference current Ia is provided. If, on the other hand, the image signal represents 1 to 3, the APC control unit 311 equally controls the density level corresponding to the image signal by equally controlling the currents between the threshold current Ith and the maximum current If for outputting the maximum amount of light P.

The functional block of the APC control unit 311 that performs the above-described control will be described next with reference to FIG. 4A. The APC control unit 311 includes a sampling unit 422, a derivation unit 423, a bias current determining unit 424, and a current supply unit 421.

The current supply unit 421 performs control to cause a current corresponding to an input image signal that is input to the semiconductor laser 43. Specifically, the current supply unit 421 inputs signals to the logic elements 312 and 313 to switch the switches 305, 306 and 307 so as to drive the current sources. The current supply unit 421 also adjusts the current values that are output by the current sources.

The current supply unit 421 includes an adjustment unit 425 for inputting a current corresponding to the image signal to the semiconductor laser 43. For example, when the image signal represents the minimum density level, the adjustment unit 425 drives only the bias current source 304 without outputting signals to the logic elements 312 and 313. Thereby, only the bias current Ib is supplied to the semiconductor laser 43. If, on the other hand, the image signal represents a density level above the minimum density level, the adjustment unit 425 outputs signals to the logic elements 312 and 313, thereby switching the switches 305, 306 and 307 to allow them to output the desired current corresponding to the image signal. As used herein, “signals” refers to a full lighting signal Sf and a partial lighting signal Sh. Accordingly, if an image signal represents a value above the minimum density level, the adjustment unit 425 outputs at least one of the full lighting signal Sf and the partial lighting signal Sh depending on the image signals.

The sampling unit 422 samples a first amount of light corresponding to a first current that is larger than the threshold current Ith and a second amount of light corresponding to a second current that is larger than the first current. The sampled amounts of light are stored in capacitors provided in the APC control unit 311, and are used by the derivation unit 423 to determine the threshold current Ith.

The derivation unit 423 derives the threshold current Ith from the relationship among the first and second currents, and the sampled first and second amount of light. The derivation unit 423 includes, in order to derive the threshold current Ith, a calculation unit 426 and a threshold current determination unit 427. The calculation unit 426 calculates a linear function representing the relationship between the current that is input to the semiconductor laser 43 and the amount of light, based on the first and second currents, and the sampled first and second amount of light. The threshold current determination unit 427 sets the current at which the amount of light is zero in the calculated linear function to the threshold current Ith.

The bias current determination unit 424 determines the bias current Ib of the semiconductor laser 43 by subtracting a predetermined difference current Ia value from the derived threshold current Ith value. When the threshold current Ith and the bias current Ib are set, the current supply unit 421 controls the current sources to output the adjusted current values.

The circuit configuration of the APC control unit 311 will be described next with reference to FIG. 4B. As shown in FIG. 4B, the APC control unit 311 includes analog switches 402 and 407, capacitors 403 and 408, comparators 405 and 411, D/As 404 and 410, a threshold current calculation unit 412, a bias current calculation unit 413, and an one-third multiplier 409. APC control (amount of light adjustment) is executed by the control of these components by the functional block shown in FIG. 4A. The control of the APC control unit 311 which includes these components will be described below.

First, the current source 421 sets provisional current values for the difference current source 303 and the bias current source 304 to determine the bias current Ib of the semiconductor laser 43. Specifically, the current supply unit 421 sets the bias current Ib and the difference current Ia to predetermined currents, and after that, the switches 306 and 307 are turned on by the partial lighting signal Sh. This drives the drive current source 302 and the difference current source 303. The bias current source 304 is driven whenever the semiconductor laser 43 is driven. Accordingly, the semiconductor laser 43 is supplied with the drive current I0 serving as a first current, and the difference current Ia and the bias current Ib. It is desirable that the bias current Ib set at this time is a current value obtained by adding a predetermined current value to the current value used previously. This is necessary to derive a linear function representing the characteristics of a region above the threshold current Ith. In other words, in this case, Ib+Ia is set to produce a value above the previous threshold current. It is also possible to set Ib+Ia+I0 to produce a value above the previous threshold current. In this case, the current value used previously is set to the drive current I0.

When the semiconductor laser 43 emits light, the PD sensor 44 outputs a current (a monitor current) corresponding to the amount of received light. Subsequently, the monitor current is converted to a voltage by the current/voltage converting unit 309. Further, a voltage Vpd that has been amplified by the amplifier 310 is input to the APC control unit 311 in a non-image region covered by a single scan. This voltage Vpd is sampled after the analog switch 407 is switched by the partial lighting signal Sh from the printer control unit 314. This sampled voltage Vh (first amount of light) is stored in the capacitor 408 and held in the image region. This sampling process is controlled collectively by the sampling unit 422.

An amount of light setting value Pow input by the printer control unit 314 is input to the one-third multiplier 409, and a value equal to one third of the amount of light setting value Pow is input to the D/A 410. The D/A 410 outputs an analog voltage DAh corresponding to the input value to the comparator 411. The comparator 411 compares the sampled/held voltage Vh and the voltage DAh equal to one third of the amount of light setting value Pow, and outputs a difference signal ΔI0. The amount of light setting value Pow is the maximum amount of light that is necessary to achieve a density level corresponding to the image signal.

The current supply unit 421 controls the value of the current I0 of the drive current source 302 to eliminate the difference signal ΔI0. Specifically, if the sampled/held voltage Vh is smaller than DAh, that is, if the amount of light is lower than the setting value, the current supply unit 421 increases the amount of the current I0 that flows through the drive current source 302 close to DAh. If, on the other hand, the sampled/held voltage Vh is larger than DAh, that is, if the amount of light is higher than the setting value, the current supply unit 421 reduces the amount of the current I0 that flows through the drive current source 302 close to DAh. In other words, the foregoing sets a current that is output when DATA0 of a two-bit image signal (DATA1 and DATA0) is 1. Here, a current Ih (=Ib+Ia+I0) is set to one third of the maximum amount of light.

Next, the current supply unit 421 turns on the switches 305, 306 and 307 by the full lighting signal Sf while fixing the values of the bias current Ib, the difference current Ia and the above-described drive current I0. Thereby, the drive current source 301 is driven as well. Accordingly, the semiconductor laser 43 is supplied with the bias current Ib serving as a second current, and the difference current Ia and the drive currents I0 and I1. Meanwhile, the voltage Vpd input to the APC control unit 311 is input to the analog switch 402. This analog switch 402 is switched by the full lighting signal Sf from the printer control unit 314, and samples the Vpd. The sampled voltage Vh (second amount of light) is stored in the capacitor 403 and held in the image region. The amount of light setting value Pow input by the printer control unit 314 is input directly to the D/A 404, and an analog voltage DAf corresponding to the input value is output to the comparator 405.

The comparator 405 compares the sampled/held voltage Vf and the voltage DAf derived from the amount of light setting value Pow, and outputs a difference signal ΔI1. The current supply unit 421 controls the value of the current I1 of the drive current source 301 to eliminate the difference signal ΔI1. Specifically, if the sampled/held voltage Vf is smaller than DAf, that is, if the amount of light is lower than the set value, the current supply unit 421 increases the amount of the current I1 that flows through the drive current source 301 close to DAf. If, on the other hand, the sampled/held voltage Vf is larger than DAf, that is, if the amount of light is larger than the set value, the current supply unit 421 reduces the amount of the current I1 that flows through the drive current source 301 closer to DAh. In other words, the foregoing sets a current that is output when DATA1 of a two-bit image signal (DATA1 and DATA0) is 1. Here, a current If (=Ib+Ia+I0+I1) is set to the maximum amount of light. Further, Ib+Ia+I1 is a current (equal to ⅔ of Pow) for reproducing a density level when the image signal represents 2.

The voltages Vf and Vh held by the capacitors 403 and 408 respectively during the above-described control process are input to the threshold current calculation unit 412. The threshold current calculation unit 412 is controlled collectively by the derivation unit 423, and derives a threshold current Ith. Specifically, the threshold current calculation unit 412 calculates a linear function based on the voltage Vf corresponding to full lighting shown in FIG. 5, the current value If (=I1+I0+Ia+Ib) corresponding to the voltage Vf, the voltage Vh corresponding to one-third lighting, and the current value Ih (=I0+Ia+Ib) corresponding to the voltage Vh. Further, a threshold current Ith at which the line intersects with a voltage of 0 V in the calculated linear function is calculated.

The determined threshold current Ith is output to the bias current calculation unit 413. The bias current calculation unit 413 is controlled collectively by the bias current determining unit 424. Specifically, the bias current calculation unit 413 generates a bias current Ib which is a current obtained by subtracting a predetermined difference current Ia from the determined threshold current Ith. The current supply unit 421 adjusts the bias current source 304 to the generated bias current Ib.

Using the bias current Ib and the difference current Ia determined in the above-described manner, the APC control unit 311 determines drive currents I0 and I1 in the same manner as described above. In this embodiment, a predetermined difference current Ia is subtracted from the threshold current Ith to generate the bias current Ib, but it is also possible that the bias current Ib is determined as the ratio to the threshold current Ith, and a difference current obtained therefrom may be set to Ia. In other words, if Ib/Ith=α, Ia may be determined in accordance with Ia=Ith−Ith×α.

As described above, if a bias current Ib and a difference current Ia are determined, a switching current (drive current) I0 for DATA0, which is the low-order bit of the image signal, and a switching current (drive current) I1 for DATA1, which is the high-order bit of the image signal, are determined. As shown in FIG. 5, the addition of I0 to the threshold current Ith is equal to an amount of light equivalent to P/3. Likewise, the addition of I1 to the threshold current Ith is equal to an amount of light equivalent to 2P/3. Further, the addition of I0 and I1 to the threshold current Ith is equal to an amount of light equivalent to the maximum amount of light P.

Accordingly, after the above-described APC control finishes, the density level corresponding to the image signal can be reproduced in equally divided levels by using the determined bias current Ib, difference current Ia and drive currents I1 and I0 corresponding to two bit image signals. Specifically, if either of DATA1 and DATA0 of the image signal is set to 1, the logic element 308 is activated to drive the difference current source 303. Accordingly, the bias current Ib, the difference current Ia, and at least one of the drive currents I0 and I1 that corresponds to the image signal are input to the semiconductor laser 43. Thereby, the APC control unit 311 can control the amount of light in three different levels divided equally between the light-emitting point of the threshold current to full lighting (amount of light P). Conversely, if neither of DATA1 and DATA0 of the image signal is set to 1, that is, if the image signal represents 0, the logic element 308 is deactivated, and only the bias current Ib flows through the semiconductor laser 43. Because the semiconductor laser 43 is driven only by the bias current Ib, which is sufficiently lower than the threshold current Ith, the occurrence of image fogging can be suppressed. The above-described control can be achieved by APC control with several scans. Therefore, unlike conventional technology, the time required to determine a current for low density portions is unnecessary.

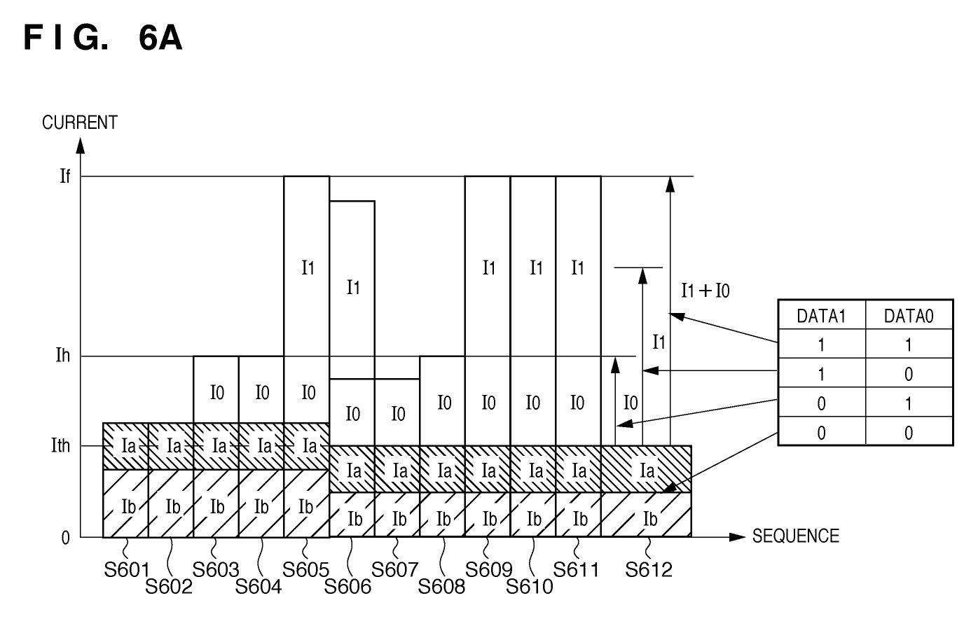

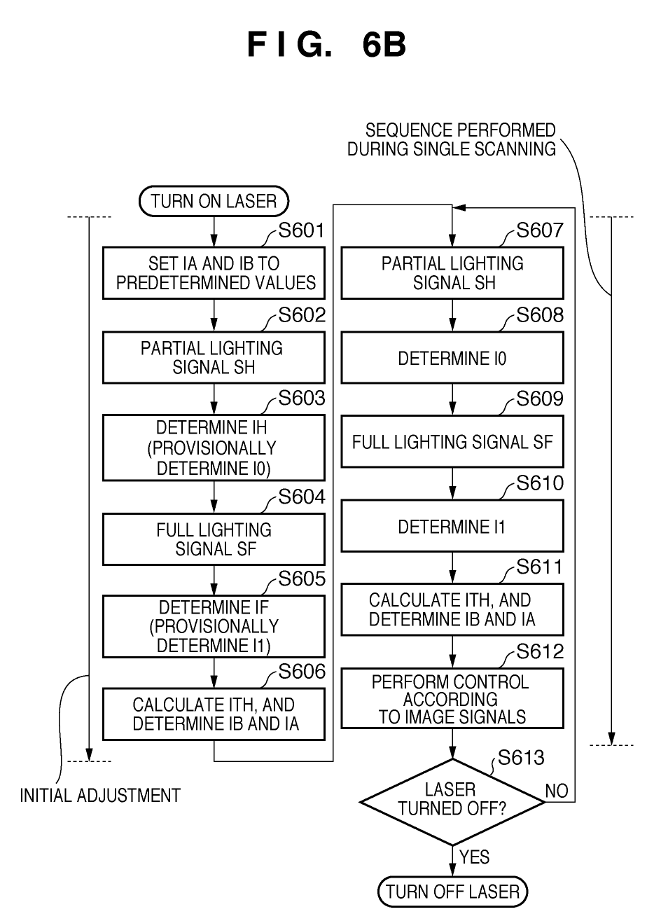

The current input to the semiconductor laser 43 that varies during the APC control and the procedure of the APC control will be described with reference to FIGS. 6A and 6B. FIG. 6A is a diagram illustrating current changes in the APC control according to the present embodiment. FIG. 6B is a flowchart illustrating the procedure of the APC control process according to the present embodiment.

In FIG. 6A, the process sequence of the APC control unit 311 shown in FIG. 6B is plotted on the horizontal axis, and the bias current Ib, difference current Ia, and drive currents I0 and I1 that are used in the process are plotted in the vertical axis. The operation of the APC control unit 311 will be described below with reference to the flowchart shown in FIG. 6B.

First, when the semiconductor laser 43 is turned on to start image formation, in step S601, the APC control unit 311 sets provisional current values for the bias current Ib and the difference current Ia. Subsequently, in step S602, the APC control unit 311 acquires a partial lighting signal Sh from the printer control unit 314 to drive the drive current source 302, the difference current source 303 and the bias current source 304. While scanning is performed several times in this state, in step S603, the APC control unit 311 sets the total of the currents that flow through the current sources 302 to 304 to Ih (held voltage Vh).

Next, in step S604, the APC control unit 311 acquires a full lighting signal Sf from the printer control unit 314 to drive all of the current sources (301 to 304). While scanning is performed several times in this state, in step S605, the APC control unit 311 sets the total of the currents that flow through the current sources (301 to 304) to If (held voltage Vf).

After the currents Ih and If are set, in step S606, the APC control unit 311 calculates a threshold current Ith based on these values, and determines the bias current Ib. The process up to this point is the initial adjustment that starts from when the semiconductor laser 43 is turned on to when the amount of light has been controlled. When the initial adjustment finishes, an image forming operation is performed. The above-described control flow may be repeated for each scan during image formation. It is desirable that the initial adjustment is performed, for example, when the printer 100 is turned on.

Upon receiving a request to form an image, in step S607, the APC control unit 311 outputs a partial lighting signal Sh from the printer control unit 314 in a non-image region covered by a single scan to drive the semiconductor laser 43. Subsequently, in step S608, the APC control unit 311 determines a drive current I0 from the amount of light obtained from the driving of S607.

Next, in step S609, the APC control unit 311 acquires a full lighting signal Sf from the printer control unit 314 to drive the semiconductor laser 43. Subsequently, in step S610, the APC control unit 311 determines a drive current I1 from the amount of light obtained from the driving of S609. Further, in step S611, the APC control unit 311 calculates a threshold current Ith in a non-linear region covered by the same scan in the same manner as in S606, and corrects the bias current Ib and the difference current Ia. In the semiconductor laser 43, the threshold current Ith varies depending on the ambient temperature, and so on. Accordingly, it is desirable that a correction is made for each image formation as in the process ranging from S607 to S611. The process ranging from S607 to S611 is an operation performed after the amount of light is controlled once in the initial adjustment, and therefore it finishes in shorter time than the initial adjustment (S601 to S606). After the amount of light is adjusted, in the image region covered by the same scan (step S612), the APC control unit 311 controls the current that flows through the semiconductor laser 43 according to the image signals shown in the table on the right side of FIG. 6A. Further, in step S613, the APC control unit 311 determines whether or not the laser is turned off. If the laser is turned off, the APC control unit 311 terminates the process. If, on the other hand, the laser is turned on, the APC control unit 311 moves the process to S607. In other words, the serial process ranging from S607 to S612 is started when image formation is started, and is repeated until the laser is turned off.

As described above, the APC control unit 311 according to the present embodiment calculates a threshold current Ith, and sets threshold switching currents (drive currents I0 and I1) that perform switching according to image signals to be larger than the threshold current. Thereby, it is possible to control the amount of light in equally divided levels between the amount of light of low density portions to the maximum amount of light of high density portions. Further, a configuration that keeps the difference current Ia from flowing when the image signal represents 0, that is, the minimum density level, is employed, and it is therefore possible to ensure that the laser is driven only by the bias current Ib which is smaller than the threshold current Ith, so that image fogging can be suppressed.

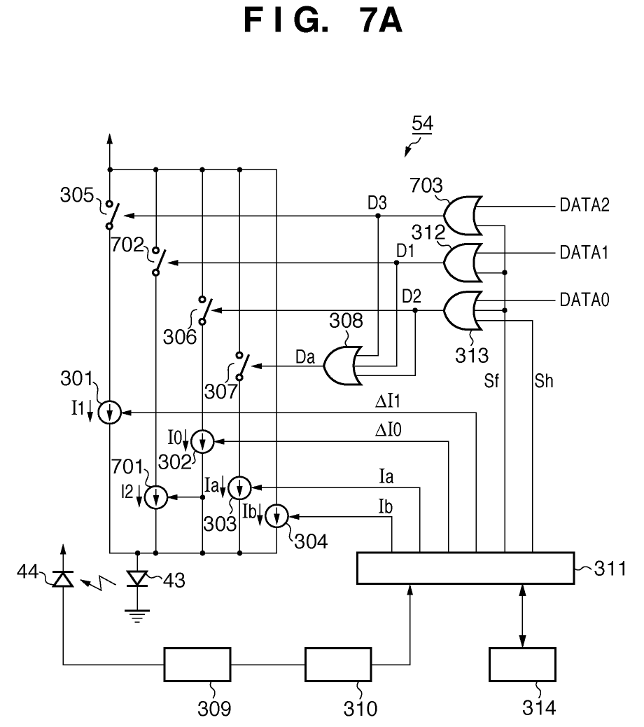

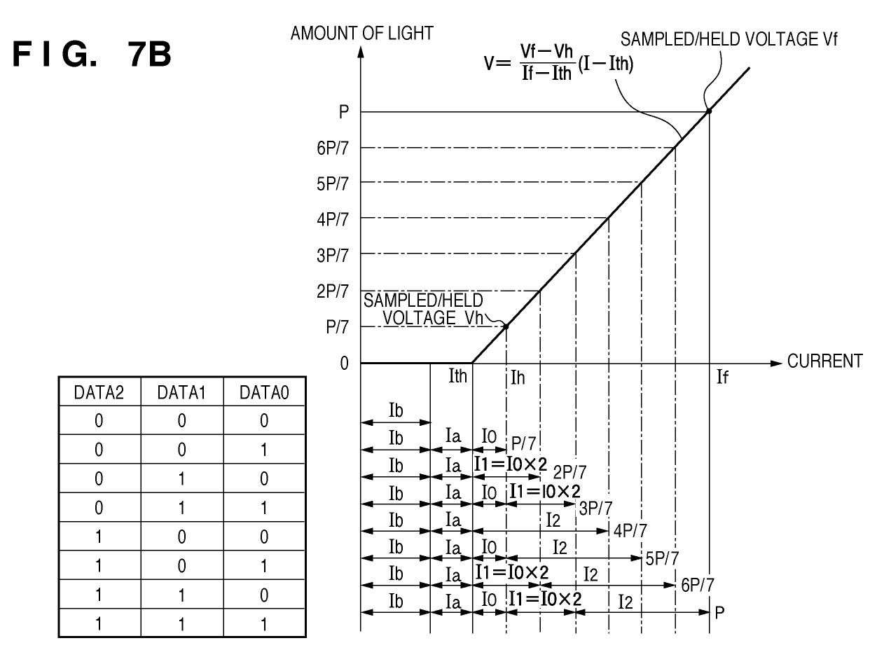

In the present embodiment, a case where the image signal has two bits has been described, but the image signal may have three bits or more. In this case, control is performed in the same manner as in the case where the image signal has two bits. Hereinafter, a case where the image signal has three bits will be described with reference to FIGS. 7A and 7B. FIG. 7A is a block diagram illustrating the configuration of the laser drive control unit 54 when the image signal has three bits. FIG. 7B is a diagram used to illustrate the currents that are set when the image signal has three bits. Only the differences in configuration from the case where the image signal has two bits will be described here.

The laser drive control unit 54 includes the configuration shown in FIG. 3, and further includes a drive current source 701, a switch 702, and a logic element 703. The switch 305 connected to the drive current source 301 is switched by an output D3 of the logic element 703. The switch 702 connected to the drive current source 701 is switched by an output D1 of the logic element 312. The switch 306 connected to the drive current source 302 is switched by an output D2 of the logic element 312.

Accordingly, the switch 307 connected to the drive current source 303 is switched by an output Da of the logic element 308 to which the outputs D1, D2 and D3 are input. The drive current source 301 corresponds to DATA2 of the image signal having three bits (DATA2, DATA1 and DATA0). Similarly, the drive current source 701 corresponds to DATA1, and the drive current source 302 corresponds to DATA0.

A drive current I2 that is set by the drive current source 701 is set to be twice the drive current I0. Further, the one-third multiplier 409 shown in FIG. 4B is replaced by a one-seventh multiplier. With this replacement, as shown in FIG. 7B, the drive current (switching current) corresponding to each bits are equal to an amount that is x-seventh of the maximum amount of light P. In other words, the drive current source 302 is set to provide a current equivalent to one seventh of the maximum amount of light P. Similarly, the drive current source 701 is set to provide a current equivalent to two sevenths of the maximum amount of light P. The drive current source 301 is set to provide a current equivalent to four sevenths of the maximum amount of light P. Thereby, as shown in FIG. 7B, the APC control unit 311 can control the amount of light in seven different levels divided equally between the amount of light of low density portions and the amount of light P of high density portions by controlling each switch according to image signals (1 to 7). If the image signal represents 0, only the bias current Ib is input to the semiconductor laser 43.

As described above, the image forming apparatus according to the present embodiment derives a threshold current of the emitting unit (semiconductor laser 43) using a first current that is larger than the threshold current and a second current that is larger than the first current. Further, the image forming apparatus determines a bias current of the emitting unit by subtracting a predetermined difference current from the threshold current. Thereby, the image forming apparatus can input only the bias current to the emitting unit when the density level is minimum, and control the current in equally divided levels between the threshold current and the maximum current when the density level is above the minimum density level. Accordingly, the present invention can provide an image forming apparatus and an optical scanning apparatus that have a low cost configuration and provide good tone reproduction capability ranging from a low density portion corresponding to the amount of light of the threshold current to a high density portion corresponding to the maximum amount of light. Furthermore, because the difference current between the threshold current and the bias current can be changed according to the image signals, image fogging can be suppressed by allowing only the bias current to flow depending on the image signals.

It should be understood that the present invention is not limited to the above-described embodiments, and various modifications can be made. The image forming apparatus includes a bias current source, a difference current source, and a plurality of drive current sources, and can adjust a current that is input to the light-emitting unit by selecting at least one of the bias current source, the difference current source, and the plurality of drive current sources according to a density level reproduced. Thereby, the image forming apparatus of the present invention can adjust the density level equally with a simple control, and therefore can suppress image fogging in low density portions.

The image forming apparatus of the present invention may be configured such that the difference current source is driven when at least one of the plurality of drive current sources is driven. Specifically, the image forming apparatus of the present invention can be configured such that the difference current source is driven automatically when a drive current source is driven. In other words, in the image forming apparatus of the present invention, the light-emitting unit can be automatically driven only by the bias current when reproducing the minimum density level. Thereby, the image forming apparatus of the present invention can further easily suppress image fogging in low density portions.

Further, in the image forming apparatus of the present invention, the linear function representing the relationship between the current that is input to the light-emitting unit and the amount of light that is output from the light-emitting unit may be calculated based on the data sampled when deriving the threshold current. In this case, the image forming apparatus can set the current at which the amount of light is zero in the calculated linear function to a threshold current. Accordingly, the image forming apparatus of the present invention can determine a threshold current by a control with little processing load.

In the image forming apparatus of the present invention, the first current value used for sampling may be a value obtained by adding a present current value to the previously determined threshold current value. Thereby, it is possible to reliably derive the relationship between the amount of light and the current that increases linearly without receiving any influence of the characteristics of the currents equal to or less than the threshold current that cause the light-emitting unit to provide unstable output. Accordingly, the image forming apparatus of the present invention can perform a more accurate adjustment of the amount of light.

Further, each drive current source may supply a current according to each bits of an image signal that represents the density level. Thereby, the image forming apparatus of the present invention can easily control the amount of light adjusted according to the image signals during image formation.

The present invention can provide an image forming apparatus that, for example, adjusts the amount of light of a light-emitting unit with high accuracy and suppresses an increase in control time that is required to adjust the amount of light, a scanning optical apparatus, and control methods thereof.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-180154 filed on Jul. 9, 2007, which is hereby incorporated by reference herein in its entirety.

What is claimed is:

1. An image forming apparatus wherein an amount of light for forming an electrostatic latent image is adjusted according to a density level of an image to be formed, the image forming apparatus comprising:
a light-emitting unit adapted to emit light in an amount of light corresponding to an input current;
a light-receiving unit adapted to output a current corresponding to an amount of received light;
a sampling unit adapted to sample a first amount of light corresponding to a first current that is larger than a threshold current, and a second amount of light corresponding to a second current that is larger than the first current using the light-emitting unit and the light-receiving unit to derive the threshold current, which is a current at which the amount of light emitted by the light-emitting unit starts to increase linearly;
a derivation unit adapted to derive the threshold current from the relationship among the first and second currents, and the sampled first and second amount of light;
a bias current determination unit adapted to determine a bias current of the light-emitting unit by subtracting a value of a predetermined difference current from a value of the derived threshold current; and
a current supply unit adapted to supply the bias current to the light-emitting unit when causing the light-emitting unit to emit light in an amount of light corresponding to a minimum density level, and supply a current that is larger than the threshold current to the light-emitting unit when causing the light-emitting unit to emit light in an amount of light corresponding to a density level that is larger than the minimum density level.

2. The image forming apparatus according to claim 1, further comprising:
a bias current source adapted to output the bias current;
a difference current source adapted to output the difference current; and
a plurality of drive current sources adapted to cause the light-emitting unit to emit light in an amount of light corresponding to the density level;
wherein the current supply unit comprises an adjustment unit adapted to select at least one of the bias current source, the difference current source, and the drive current sources, and adjust a current supplied to the light-emitting unit according to the density level.

3. The image forming apparatus according to claim 2, wherein when the adjustment unit causes at least one of the plurality of drive current sources to supply a current, it also causes the difference current source to supply a current.

4. The image forming apparatus according to claim 2, wherein the derivation unit comprises:
a calculation unit adapted to calculate a linear function that represents the relationship between the current input to the light-emitting unit and the amount of light from the first and second currents, and the sampled first and second amount of light; and
a threshold current determination unit adapted to set a current at which the amount of light is zero in the calculated linear function to the threshold current.

5. The image forming apparatus according to claim 2, wherein the first current has a value obtained by adding a predetermined current value to the previously determined threshold current.

6. The image forming apparatus according to claim 2, wherein each drive current sources supply a current corresponding to each bits of an image signal that represents the density level.

7. A scanning optical apparatus that is included in an image forming apparatus wherein an amount of light for forming an electrostatic latent image is adjusted according to a density level of an image to be formed, the scanning optical apparatus comprising:
a light-emitting unit adapted to emit light in an amount of light corresponding to an input current;
a light-receiving unit adapted to output a current corresponding to an amount of received light;
a sampling unit adapted to sample a first amount of light corresponding to a first current that is larger than a threshold current, and a second amount of light corresponding to a second current that is larger than the first current using the light-emitting unit and the light-receiving unit to derive the threshold current, which is a current at which the amount of light emitted by the light-emitting unit starts to increase linearly;
a derivation unit adapted to derive the threshold current from the relationship among the first and second currents, and the sampled first and second amount of light;
a bias current determination unit adapted to determine a bias current of the light-emitting unit by subtracting a value of a predetermined difference current from a value of the derived threshold current; and
a current supply unit adapted to supply the bias current to the light-emitting unit when causing the light-emitting unit to emit light in an amount of light corresponding to a minimum density level, and supply a current that is larger than the threshold current to the light-emitting unit when causing the light-emitting unit to emit light in an amount of light corresponding to a density level that is larger than the minimum density level.

8. A method for controlling an image forming apparatus that includes a light-emitting unit adapted to emit light in an amount of light corresponding to an input current and a light-receiving unit adapted to output a current corresponding to an amount of received light, and adjusts an amount of light for forming an electrostatic latent image according to a density level of an image to be formed, the method comprising the steps of:
sampling a first amount of light corresponding to a first current that is larger than a threshold current, and a second amount of light corresponding to a second current that is larger than the first current using the light-emitting unit and the light-receiving unit to derive the threshold current, which is a current at which the amount of light emitted by the light-emitting unit starts to increase linearly;
deriving the threshold current from the relationship among the first and second currents, and the sampled first and second amount of light;
determining a bias current of the light-emitting unit by subtracting a value of a predetermined difference current from a value of the derived threshold current; and
supplying the bias current to the light-emitting unit when causing the light-emitting unit to emit light in an amount of light corresponding to a minimum density level, and supply a current that is larger than the threshold current to the light-emitting unit when causing the light-emitting unit to emit light in an amount of light corresponding to a density level that is larger than the minimum density level.

9. A method for controlling a scanning optical apparatus that is included in an image forming apparatus that includes a light-emitting unit adapted to emit light in an amount of light corresponding to an input current and a light-receiving unit adapted to output a current corresponding to an amount of received light, and adjusts an amount of light for forming an electrostatic latent image according to a density level of an image to be formed, the method comprising the steps of:
sampling a first amount of light corresponding to a first current that is larger than a threshold current, and a second amount of light corresponding to a second current that is larger than the first current using the light-emitting unit and the light-receiving unit to derive the threshold current, which is a current at which the amount of light emitted by the light-emitting unit starts to increase linearly;
deriving the threshold current from the relationship among the first and second currents, and the sampled first and second amount of light;
determining a bias current of the light-emitting unit by subtracting a value of a predetermined difference current from a value of the derived threshold current; and
supplying the bias current to the light-emitting unit when causing the light-emitting unit to emit light in an amount of light corresponding to a minimum density level, and supply a current that is larger than the threshold current to the light-emitting unit when causing the light-emitting unit to emit light in an amount of light corresponding to a density level that is larger than the minimum density level.
